(19) United States
(12) Patent Application Publication
(10) Pub. No.: US 2011/0061955 A1
(43) Pub. Date: Mar. 17, 2011

(54) DRIVE TRAIN ARRANGEMENT FOR A VEHICLE

(75) Inventor: Rayk Hoffmann, Friedrichshafen (DE)

(73) Assignee: ZF FRIEDRICHSHAFEN AG, Friedrichshafen (DE)

(21) Appl. No.: 12/991,580

(22) PCT Filed: May 6, 2009
(86) PCT No.: PCT/EP09/55474

§ 371 Date: Nov. 16, 2010

(30) Foreign Application Priority Data
May 21, 2008 (DE) 10 2008 001 899.6

(51) Int. Cl. B60K 6/48; B60K 5/00

(52) U.S. Cl. 180/65.25; 180/54.1; 903/902; 180/65.22

(57) ABSTRACT

A drivetrain arrangement (1) for a vehicle with an internal combustion engine (2) which is coupled by at least one clutch (3) to an automatic transmission (4) such that at least one direct gear ratio can be produced at the driven axle of the vehicle. At least one further power source is provided for applying an additional drive torque, as a power reserve, the driven axle of the vehicle.

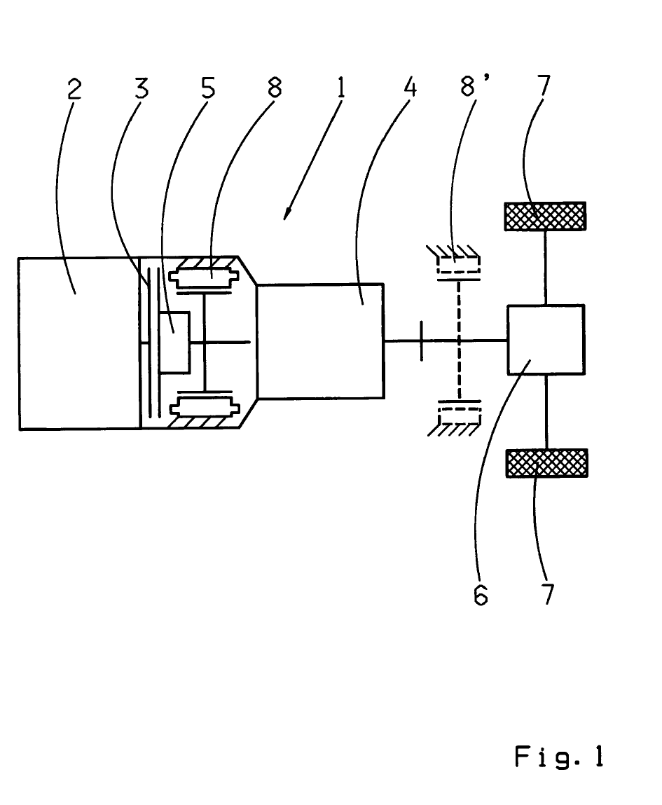

This application is a National Stage completion of PCT/EP2009/055474 filed May 6, 2009, which claims priority from German patent application serial no. 10 2008 001 899.6 filed May 21, 2008.

### FIELD OF THE INVENTION

The present invention concerns a drivetrain arrangement for a vehicle.

### BACKGROUND OF THE INVENTION

Drivetrain arrangements for vehicles are known from automotive technology. The drivetrain, for example of a long-distance utility vehicle, comprises an internal combustion engine connected for example by a clutch to a multi-stage transmission which provides appropriate gear ratios at the drive axle of the utility vehicle. The drivetrain must be matched in relation to the required driving performance of the utility vehicle and the available engine power of the internal combustion engine. In that context the so-termed torque ceiling of the internal combustion engine determines the gear spread of the transmission as a function of the number of gear ratio steps. Here, drivability and shifting frequency in combination with the unit power of the utility vehicle are the essential prerequisites. Accordingly, the operating point and the power excess of the internal combustion engine must be selected for a particular weight of the vehicle. Vehicles, however, in particular utility vehicles for example used for long journeys, are often not fully laden or travel along very level routes, so that the internal combustion engine of the vehicle is operated with considerable excess power, and this has an adverse effect on the fuel consumption of the vehicle.

### SUMMARY OF THE INVENTION

Accordingly, the purpose of the present invention is to propose a drivetrain arrangement for a vehicle of the type described at the start, with which fuel consumption is achieved without adverse effect on the drivability and shifting frequency.

According to these, a drivetrain arrangement for a vehicle, in particular a utility vehicle operated over long distances and having an internal combustion engine is proposed, which is coupled by at least one clutch to an automatic transmission, wherein a direct gear ratio can be produced at the driven axle of the vehicle and wherein at least one further power source is provided for applying additional drive torque as a power reserve.

By virtue of the drivetrain arrangement proposed according to the invention a drivetrain configuration optimized in relation to driving comfort and fuel consumption is obtained, in which the gear ratio at the transmission and the wheels is reduced by at least one step interval. The vehicle's efficiency is increased by the use of a ‘fast’ ratio at the rear axle, since the operating point of the internal combustion engine is displaced in the performance diagram along the constant power line. This results in consumption savings of the vehicle, of up to 8 percent depending on the roads on which it is used. During this, due to the existing additional power source the driving comfort is preserved or improved and the drivability of the vehicle is re-established. Thus, otherwise necessary measures such as carrying out powershifts or the use of infinitely variable range groups are not needed.

Consequently, the combination of an additional power source and an extreme-ratio rear axle is in this case decisive and combines the fuel-saving potential of the fast-drive axle with that of a hybrid drive in a vehicle. Thus, in the drivetrain arrangement according to the invention no gearshift is triggered when the driving resistance changes, since the power shortfall due to the driving resistance change is compensated for by the additional power source. Accordingly the better efficiency in the highest gear can be used further, and downshifts due to power shortfall are avoided.

Preferably, the additional drive torque of the power source can be applied to the rear axle of the utility vehicle constituting the drive axle. According to an advantageous embodiment variant of the invention, for this it can be provided that as the power source an electric machine or the like arranged in parallel in the drivetrain is used. For example, the electric machine can be arranged on the primary and/or the secondary side of the transmission. When an electric machine or electric motor is used as the additional power source, a hybrid drivetrain arrangement can be used. However, other power sources too can be used.

A possible design of the invention can provide that the electric machine is coupled to the transmission input shaft or even, for example, on the drive output side of the multi-stage transmission. The electric machine can be coupled directly to the drivetrain, or indirectly, for example via a clutch or the like. In this way the additional drive torque can if necessary be introduced on the transmission input side, for example if a power shortfall or the like occurs. It is also possible, however, for the electric machine to be associated with a rear axle of the vehicle. The additional drive torque can then be applied directly to the drive axle, for example the rear axle, or even directly to the wheels to be driven.

As the electric machine, for example an integrated starter generator or a crankshaft starter generator can be provided. The integrated starter generator can also be used for driving under electric power. The crankshaft starter generator can preferably be coupled permanently to the crankshaft of the internal combustion engine in order to start the latter.

The drivetrain arrangement proposed according to the invention can preferably be used in a utility vehicle operated over long distances. However, other fields of application are also possible.

### BRIEF DESCRIPTION OF THE DRAWINGS

The present invention will now be explained in more detail with reference to the drawing.

### DETAILED DESCRIPTION OF THE PREFERRED EMBODIMENTS

The single FIGURE illustrating the invention shows the principle of a possible embodiment variant of a drivetrain arrangement 1 according to the invention for a vehicle used as a utility vehicle.

The proposed drivetrain arrangement 1 of the utility vehicle operated on long-distance journeys comprises an internal combustion engine 2 coupled by a clutch 3 to an automatic transmission 4, for example a multi-stage transmission, on the transmission input side. The clutch 3 is actuated by a clutch-release mechanism 5. On its drive output side the transmission 4 is connected to a rear axle 6 of the utility vehicle (no more of which is shown) for driving the wheels 7.

According to the invention, in the drivetrain arrangement 1 proposed it is provided that the transmission 4 has at least one direct gear ratio to that a rear axle 6 can be provided with a so-termed ‘fast’ ratio. In addition, the proposed drivetrain arrangement 1 comprises at least one further power source for applying an additional drive torque as a power reserve, in order to compensate for a power shortfall caused by a change of the driving resistance of the utility vehicle.

In the embodiment variant shown this additional power source consists, for example, of at least one electric machine or electric motor 8, 8′. As an example the electric machine 8 is in the form of an integrated starter generator coupled to the transmission input shaft of the transmission 4.

Optionally, the electric machine 8′ can also be arranged on the secondary side of the transmission 4 and coupled to the transmission output, as indicated by the broken line in the FIGURE. The electric machine 8′ can be provided alternatively or even in addition to the electric machine 8.

The drivetrain configuration 1 illustrated in the FIGURE with a fast rear axle ratio and with the additional electric drive is preferably used in long-distance trucks. When the driving resistance changes, by using the fast, consumption-optimized rear axle ratio a downshift due to a power shortfall in the utility vehicle can be avoided, since the electric drive or electric machine 8, 8′ is used for so-termed boosting, to make up the power shortfall.

### Indexes

1 Drivetrain arrangement
2 Internal combustion engine
3 Clutch
4 Transmission
5 Clutch release mechanism
6 Rear axle
7 Wheels
8, 8′ Electric machine

1-9. (canceled)

10. A drivetrain arrangement (1) for a vehicle comprising an internal combustion engine (2) being coupled, via at least one clutch (3), to an automatic transmission (4),
at least one direct gear ratio being produced at a driven axle of the vehicle, and
a further power source being provided for applying an additional drive torque as a power reserve.

11. The drivetrain arrangement according to claim 10, wherein the further power source provides the additional drive torque to the rear axle (6) of the vehicle which constitutes a drive axle.

12. The drivetrain arrangement according to claim 10, wherein the further power source is at least one electric machine (8, 8′) arranged in parallel in the drivetrain on at least one of a primary and a secondary side of the transmission (4).

13. The drivetrain arrangement according to claim 12, wherein the electric machine (8) is coupled to a transmission input shaft of the transmission (4).

14. The drivetrain arrangement according to claim 12, wherein the electric machine (8′) is coupled to a drive output of the transmission (4).

15. The drivetrain arrangement according to claim 12, wherein the electric machine connectable to the rear axle (6) of the vehicle.

16. The drivetrain arrangement according to claim 12, wherein the electric machine (8) is an integrated starter generator.

17. The drivetrain arrangement according to claim 12, wherein the electric machine (8) is a crankshaft starter generator.

18. The drivetrain arrangement according to claim 10, wherein the vehicle is a utility vehicle suitable for a long-distance journey.

19. A drivetrain arrangement (1) for a long-distance utility vehicle, the drivetrain arrangement comprising:
an internal combustion engine (2) being coupled, via at least one clutch (3), to an automatic transmission (4),
at least one direct gear ratio being produced at a driven axle of the vehicle, and
a further power source being provided for applying an additional drive torque as a power reserve.

20. A drivetrain arrangement (1) for a vehicle, the drivetrain arrangement comprising:
an internal combustion engine (2) being drivingly connected, via a clutch (3), with an automatic transmission (4);
a first electric machine (8) being arranged between the clutch (3) and the automatic transmission (4),
wheels (7) being connected to and driven by a drive axle (6) which is connected to and driven by an output of the automatic transmission (4),
the drive axle (6) and the output of the automatic transmission (4) being engagable with a second electric machine (8′) arranged therebetween,
a direct drive ratio being produced by the drive axle (6),
at least one of the first and the second electric machine (8, 8) being drivable to supply drive torque to the drive axle (6) in addition to drive torque supplied to the drive axle (6) from the combustion engine (2).
